(19) United States
(12) Patent Application Publication
(10) Pub. No.: US 2011/0006985 A1
(43) Pub. Date: Jan. 13, 2011

(54) DISPLAY SURFACE AND CONTROL DEVICE COMBINED THEREWITH

(76) Inventor: Robert Koeppe, Linz (AT)

Correspondence Address: BROOKS KUSHMAN P.C., 1000 TOWN CENTER, TWENTY-SECOND FLOOR, SOUTHFIELD, MI, 48075, US

(21) Appl. No.: 12/919,386

(22) PCT Filed: Feb. 26, 2009
(86) PCT No.: PCT/AT2009/000078

§ 371 Date: Aug. 25, 2010

(30) Foreign Application Priority Data
Feb. 27, 2008 (AT) A 326/2008

(51) Int. Cl. G06F 3/033

(52) U.S. Cl. 345/158

(57) ABSTRACT

The invention relates to a display surface and a control device combined therewith for a data processing system, wherein a display surface is equipped with photosensitive elements. A photosensitive element is configured as a planar position detector on the basis of a layer made of an organic photoactive material, which on both sides is connected by a planar electrode, wherein at least one electrode inside the circuit thereof has relatively high resistance, wherein the current through an electrode having poor conductivity is measured at several connecting points disposed at a distance from each other and from this conclusions may be drawn about the position of a local conductive connection through the photosensitive layer caused by light absorption. A luminous indicator produces a light spot on the display surface, the spot is detectable by the position detectors and reported to a data processing unit.

The invention relates to a display panel and a control apparatus combined therewith for a data processing installation.

By way of example, EP 1 696 300 A1 describes what is known as an optical joystick. A pivotably mounted lever is provided at one end with a light source which shines on a particular region of a panel, provided with an array of light-sensitive cells, depending on the position of the lever. Usually, the electrical signals produced thereby on the cells are read in by a computer and interpreted such that the joystick has the same effects on the computer from the point of view of the user as a joystick in which the position is taken from nonreactive resistances. Typically, the joystick is used to move a cursor symbol on the screen of the computer; depending on what location on the screen has what function associated with it, if the cursor is located therein, operation of a switch or the ENTER key then allows a particular action to be initiated. The light-sensitive cells which are illuminated from the lever of the cursor are normally not seen by the human operator. With an appropriate design, a small area of light-sensitive cells is sufficient.

DE 603 01 226 T2 and DE 69828412 T2 describe target devices which imitate a firearm but, instead of a projectile, “fire” only a short laser beam pulse at a target plate. The target plate is an area provided with light-sensitive cells which are arranged in a grid of 15 by 15 cells on an area of approximately one dm², for example. The impingement of the laser beam on one or more cells is detected electronically by said cells and, furthermore, is displayed in the vicinity of the shooter on a screen, and the accuracy of the hit can also be stored for any evaluations in a computer.

US 2007/0176165 A1 shows a design for a position detector, based on light-sensitive organic semiconductors, for an impinging spot of light. The detector, of two-dimensional design, comprises a plurality of layers. A substrate comprising glass or a flexible organic material has a first, two-dimensional electrode arranged on it which has a high nonreactive resistance. This is followed by a layer of organic photoactive materials within which a donor layer and an acceptor layer abut one another. These are in turn followed by a two-dimensional electrode which has a low nonreactive resistance, however. At the edge of said electrode, the photoactive materials are provided with two to 8 punctiform or linear, spaced connection electrodes. When a focused beam of light with a suitable wave spectrum impinges on a point on the layer of photoactive materials, a current flows through the individual connection electrodes. The magnitude of the current in the individual connection electrodes can be used to infer the proximity of said connection electrodes to the point of impingement of the beam of light and hence to calculate the point of impingement of the beam of light using a kind of triangulation.

A precursor thereto is disclosed in DE 698 05 700 T2.In this case, however, the light-sensitive material is amorphous silicon and the arrangement has only two contact electrodes and is accordingly used only for one-dimensional position finding.

U.S. Pat. No. 7,009,663 B2 shows a screen equipped with liquid crystals which is equipped with a multiplicity of light-sensitive cells which are used to sense the ambient light and which can accordingly be used to set the brightness of the image which is to be displayed in optimum fashion.

US 2005248264 A1 shows an OLED display (that is to say a display which is based on “organic light emitting diodes”) which is provided with a layer which it uses to measure its own light and ambient light in order to provide an optimum display despite changing ambient lighting and its own illumination characteristics changing during ageing.

US 2005270260 A1 shows a projection panel which is provided with light-sensitive elements and with light-emitting elements. The light-sensitive elements measure light arriving from a projector, and the light-emitting elements are prompted to amplify the light which arrives. In comparison with conventional projection panels, the electrically introducible illumination power is thus relocated from the projector to the projection panel.

EP 1680732 A2 shows a screen on which a cursor can be controlled using a luminous pointer, so that inputs can also be made. To this end, the individual pixels of the screen send not only their customary color information but also an optical pattern which is not discernible to the eye of the observer, but denotes the arrangement of said pixels on the screen. The appliance acting as a “luminous pointer” does not need to emit any light itself; instead, is provided with an optical sensor device which can recognize the denoting pattern at that screen region to which the appliance “is pointing”. The system demands special actuation of the screen pixels and a special luminous pointer.

The inventor has addressed the problem of providing a display panel and a control apparatus combined therewith for a data processing installation, wherein a cursor can be controlled on a display panel using a luminous pointer for the purpose of input to a data processing installation. In contrast to the design according to EP 1680732 A2, the apparatus to be provided is intended to be more flexible, able to be produced less expensively, able to be operated with lower software complexity and easy to operate even at a relatively large distance from the display panel.

To solve the problem, it is proposed that the display panel, which may be a screen or a projection panel, be occupied by position detectors comprising light-sensitive organic semiconductors, as are essentially described in US 2007/0176165 A1, and the signals be fed into the data processing installation by the position detectors. If a luminous pointer, for example a laser pointer or a focused light emitting diode, is used to point at the display panel, the coordinates of the small region in which the beam of light from the luminous pointer impinges on the display panel are recognized by the data processing installation using the position detectors. The operating system running on the data processing installation associates the position of a cursor, that is to say of an insertion marker, cursor or input marker which is otherwise usually moved by means of a “mouse”, on the display panel with these coordinates.

The aforementioned detectors can also be produced relatively inexpensively for large panels. If they are intended to be arranged in front of display panels, they can be constructed entirely from transparent materials. If they are themselves intended to be used as a projection panel, they can have a visually white or silvery outward appearance. If required, they may also be of mechanically flexible design like a plastic film. Hence, they can be fitted to almost all established display panels. In the case of transparent display panels, they can also be mounted behind display panels.

Account must naturally be taken of the problem that ambient light and particularly light which is produced as intended by the display panel or the projector must not be incorrectly interpreted as the point of impingement of the luminous pointer for the purpose of defining the cursor. This can essentially be done by three methods:
The spectral range of the light which is sensed by the detectors and in which the luminous pointer operates is different than that of the light arriving from the surroundings or of the light which is used for display.
The beam of light from the luminous pointer is frequency-encoded, i.e. its intensity fluctuates over time at a particular frequency. This frequency is filtered out of the signals delivered by the position detectors using communication means.
The light from the luminous pointer has a significantly higher spectral power density in a very narrow spectral range than otherwise occurs. The position detectors first of all select this spectral range as accurately as possible, and within the context of the signals detected in this process only those whose level is above a certain limit level are admitted as denoting the cursor position.

The design of position detectors used in accordance with the invention is outlined in a simplified manner and by way of example in the drawings, in which:

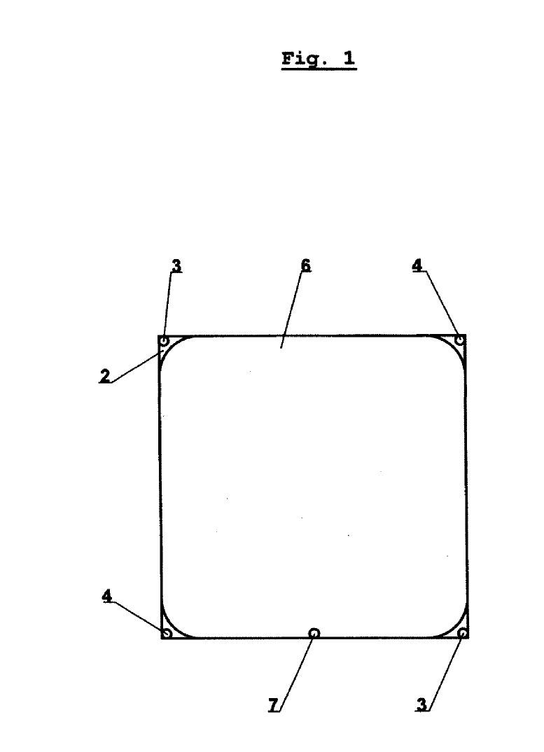

FIG. 1 shows a front view of an exemplary position detector which can be used in accordance with the invention.

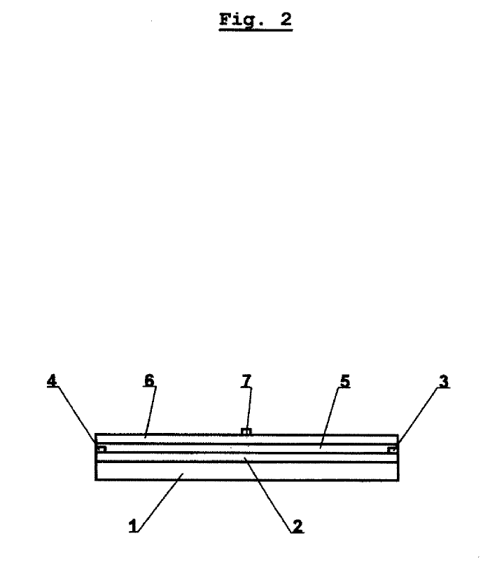

FIG. 2 shows a side view of the position detector from FIG. 1. For reasons of visibility, the layer thicknesses in this case are shown in excessively enlarged form.

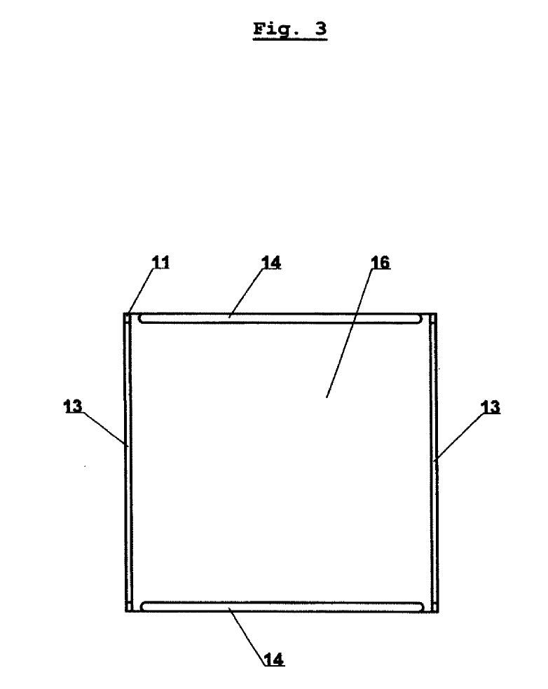

FIG. 3 shows a front view of a second exemplary position detector which can be used in accordance with the invention.

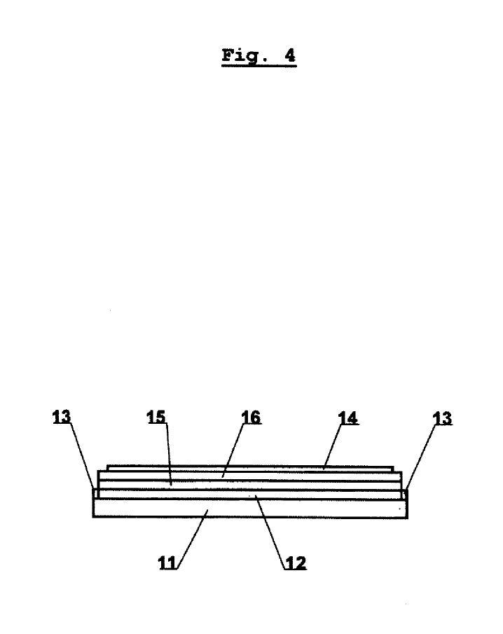

FIG. 4 shows a side view of the position detector from FIG. 3. For reasons of visibility, the layer thicknesses in this case are shown in excessively enlarged form.

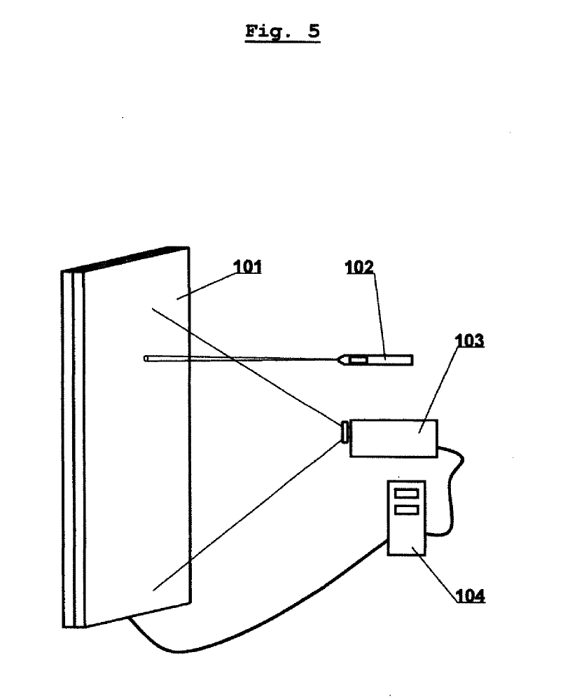

FIG. 5 shows an example of an arrangement of appliances in the application of the invention.

As shown in FIG. 1 and FIG. 2, an electrically insulating, translucent substrate 1, which may be a plastic film or a glass plate, for example, holds a transparent or semitransparent two-dimensional electrode 2 which “conducts poorly”, that is to say that although it comprises an electrically conductive material it is a significant nonreactive resistance within the system. This “poorly conductive electrode” may be a very thin metal layer, a transparent conductive oxide (TCO), a conductive polymer or it may be a carbon nanotube network. The layer thickness of this electrode is proportioned such that its surface resistance causes a significant voltage drop in a respective circuit when a current flows. Two pairs of connection points 3, 4 represent the connection between the poorly conductive electrode 2 and an external circuit. The two pairs of connection points 3, 4 are situated so as to cross one another diagonally (FIG. 1).

The layer which adjoins the “poorly conductive electrode” 2 and which is conductively connected thereto is a photoactive organic semiconductor layer 5. This layer may be a photoconductor or a photovoltaicly active element. That is to say that the absorption of light may involve its electrical resistance breaking down, or an electrical voltage can be produced between two interfaces of the layer. In the first case, the application of an external voltage may involve a flow of current, and in the second case, a current can flow by virtue of the circuit being closed via an external loop.

The second side of the photoactive organic semiconductor layer 5 has a two-dimensional electrode 6 which is conductively connected thereto and which, in comparison with the other components of the circuit, ideally has a very low nonreactive resistance. It may be formed by a metal layer, a conductive polymer, a conductive oxide or else by a carbon nanotube network. If the electrode 6 comprises the same material as the electrode 2, it should have significantly greater thickness than electrode 2. The conductivity of the electrode 6 can be supported by wires or films comprising a highly electrically conductive metal which are in contact therewith and which are conductively connected thereto. The electrode 6 can be connected to an external circuit by means of a connection point 7.

When a focused beam of light with a suitable wave spectrum impinges on a point on the photoactive organic semiconductor layer 5, a current flows through the poorly conductive electrode 2 to the connection points 3, 4. On account of the nonreactive resistance of the electrode 2, the magnitude of the current in the individual connection electrodes is highly dependent on the proximity of said electrodes to the point of impingement of the beam of light. This means that measurement of the individual currents allows the point of impingement of the beam of light to be inferred. The technology in this regard is known and therefore does not need to be described in detail at this point. In merely a skeleton laboratory experiment, it is therefore possible to use simple and inexpensive means to form a single position detector which has a square surface with a 5 cm edge length and a resolution for explicitly recognizing 16 different impingement regions for a beam of light. With a little perfecting, the resolution can certainly be improved to a significant degree. If the surface area of the position detectors is reduced, it is naturally also possible to improve the resolution.

FIG. 3 and FIG. 4 show a second design of position detectors which can be used in accordance with the invention.

Re layer structure: a substrate 11 has a poorly conductive two-dimensional electrode 12, followed by a photoactive organic semiconductor layer 15 and then in turn a poorly conductive electrode 16. The poorly conductive, two-dimensional electrodes 12, 16 arranged on both sides of the photoactive organic semiconductor layer 15 can be electrically connected to an external circuit by two respective opposite connection parts 13 and 14 which extend over an entire electrode side. In this case, the connecting line between two connection parts of an electrode is situated normally with respect to the connecting line between the two connection parts of the second electrode. Hence, the current split between the two connection parts of an electrode can be respectively associated with precisely one direction component of the distance of the point of impingement of a beam of light on the detector surface.

FIG. 5 shows an exemplary, advantageous application of the invention. A projector 103 beams an image determined by a data processing installation 104 onto a projection area 101. The projection area 101 comprises a front, white, semitransparent layer and a layer behind that comprising a grid of adjacently arranged position detectors, which may be designed like the elements shown in FIG. 1 to FIG. 4. The results supplied by the individual position detectors are supplied to the data processing installation 104 either directly or via a data line. A luminous pointer 102, for example a laser pointer, that is to say an apparatus which can emit a focused, concentrated beam of light, is used to illuminate a small region on the projection area 101. The coordinates of the spot of light thus produced on the projection area 101 become identifiable by means of the position detectors for the data processing installation 104. The data processing installation then associates a cursor with these coordinates. The cursor can thus be moved on the projection area 101 by means of the luminous pointer with such precision as is usually achieved using a computer mouse. The movement of the cursor is therefore also possible from points which are situated a long way away from the data processing installation and the projection area 101. This is particularly advantageous for the application in the field of multimedia presentations and computer games and simulations.

By frequency-encoding the individual luminous pointers—as described further above—it is also possible to distinguish between a plurality of differently encoded luminous pointers. In combination with reading electronics having frequency filters (lock-in technology), it is thus also possible to track a plurality of luminous pointers at different frequencies simultaneously.

In order to improve the selectivity of the position detectors for the light from the luminous pointer, which light extends as far as possible only over a very narrow spectral range, it is of considerable advantage, in addition to the correct selection of the materials for the photosensitive layer, to produce the electrodes on both sides of the photosensitive layer from metal and to adjust the spacing between them such that maximum absorption in the photosensitive layer occurs precisely at the wavelength of light from the luminous pointer as a result of resonance (resonant cavity enhanced). This makes detection less sensitive to background light.

A beam of light from the luminous pointer can come from an LED at the tip of an input pen, for example. It is also conceivable for the light from a luminous pointer to be composed from two spectral ranges. A first spectral range, which is invisible to the human eye, is recognized by the position detectors. The second spectral range is visible to the human eye. It is used to recognize the position of the beam of light on the display apparatus directly with the naked eye.

In one particularly advantageous embodiment, the position detectors are of entirely transparent design. Besides the aforementioned transparent structures for the substrate and the electrodes, it is also possible for the photosensitive layer to be constructed from metalized naphthalocyanines in combination with naphthalene diimide, or derivatives of these materials. It is thus possible for a surface comprising a plurality of position detectors to be put onto the front of an existing customary screen and for the screen thus to become sensitive to the actuation by means of luminous pointers in a similar manner to the aforementioned projection screen.

An elegant application option for the invention involves placing a semitransparent, writable surface, such as thin paper or a wipeable plastic film, onto a display panel of sensitive design in line with the invention and to use a pen to write or draw on it, said pen incorporating not only the customary, pigment-dispensing tip but also a luminous pointer whose beam of light points at least approximately to precisely that point at which pigment is currently being used to write or draw. The information written or drawn can thus be simultaneously picked up by the display panel and digitally stored in the data processing installation.

1. A display panel and a control apparatus combined therewith for a data processing installation, wherein the display panel is occupied by photosensitive elements, characterized in that a photosensitive element is in the form of a two-dimensional position detector on the basis of a layer of an organic photoactive material, which layer is connected on both sides by a two-dimensional electrode, that is to say an electrode covering essentially the entire area of the layer, wherein at least one of the two two-dimensional electrodes is a “poorly conductive electrode”, that is to say has such a high nonreactive resistance within its circuit that its surface resistance when a current flows causes a significant voltage drop in the respective circuit, wherein the current through the poorly conductive electrode is measured at a plurality of spaced connection points, and the relative magnitude of the different currents measured at the different connection points is used to calculate the position of a local conductive connection, brought about by light absorption, through the photosensitive layer, wherein a luminous pointer produces a spot of light on the display panel, the sensitivity of the position detectors is selectively set to the light from the luminous pointer, and the position detectors are connected to a data processing installation.

2. The display panel and the control apparatus combined therewith as claimed in claim 1, characterized in that two poorly conductive, two-dimensional electrodes have a photoactive organic semiconductor layer arranged between them, in that the poorly conductive, two-dimensional electrodes can be electrically connected to an external circuit by two respective opposite connection parts and which extend over an entire electrode side, and in that the connecting line between the two connection parts of an electrode is situated normally with respect to the connecting line between the two connection parts of the second electrode.

3. The display panel and the control apparatus combined therewith as claimed in claim 1, characterized in that the selectivity of the position detectors for sensing the spot of light from the luminous pointer in contrast to ambient light has been produced by virtue of
the sensitivity of the photosensitive elements of the position detectors being restricted to a spectral range of light which is not or only slightly contained in the ambient light, though probably is contained in the light emitted by the luminous pointer, and/or
by virtue of the beam of light from the luminous pointer fluctuating in intensity on a frequency-encoded basis and being filtered out of the signals delivered by the detectors, and/or by virtue of
the light from the luminous pointer having a higher spectral power density in a spectral range than occurs in the ambient light and by virtue of the sensitivity of the photosensitive elements being largely exclusively in this spectral range and by virtue of only electrical signals output by the photosensitive elements whose level is above a lower limit level being admitted as denoting the cursor position.

4. The display panel and the control apparatus combined therewith as claimed in claim 3, characterized in that the electrodes on both sides of the photosensitive layer comprise metal and in that the luminous pointer emits light in a spectral range in which maximum absorption occurs in the layer bounded by the two electrodes as a result of interference effects.

5. The display panel and the control apparatus combined therewith as claimed in claim 3, characterized in that a plurality of luminous pointers are used, the signals from which are frequency-encoded differently.

6. The display panel and the control apparatus combined therewith as claimed in claim 1, characterized in that the position detectors are arranged on a projection area.

7. The display panel and the control apparatus combined therewith as claimed in claim 6, characterized in that the position detectors are arranged on that side of the projection area which faces the projector and have a white layer which is semitransparent to the light from the luminous pointer on their side which faces the projector.

8. The display panel and the control apparatus combined therewith as claimed in claim 1, characterized in that the position detectors are mounted on that side of a screen which faces the user and in that they are constructed from materials which are transparent in the visible spectral range, and the luminous pointer emits light in the infrared or ultraviolet spectral range which can be absorbed by the photoactive layer.

9. The display panel and the control apparatus combined therewith as claimed in claim 1, characterized in that the display panel is overlaid with an overlay which is transparent to the light from the luminous pointer or semitransparent, writable and removable and which can be written on by an appliance which is in the form of a color-dispensing pen and a luminous pointer in equal measure, wherein the light from the luminous pointer can be detected by the photosensitive elements of the display panel.
